(19) United States
(12) Patent Application Publication
(10) Pub. No.: US 2003/0066172 A1
(43) Pub. Date: Apr. 10, 2003

(54) Cremation remains container

(76) Inventor: Daniel J. Parker, Connersville, IN (US)

Correspondence Address: Wayne L. Jacobs, Wood, Herron & Evans, L.L.P., 2700 Carew Tower, 441 Vine Street, Cincinnati, OH, 45202-2917, US

(21) Appl. No.: 09/972,093

(22) Filed: Oct. 5, 2001

(51) Int. Cl. A61G 17/00

(52) U.S. Cl. 27/1

(57) ABSTRACT

A cremation remains container simulative of an ornamental plant comprising a stem and a flower. The stem and flower are removably securable together. One of the stem and flower includes a cremation remains compartment formed therein. The compartment is made accessible by removing or separating the stem and flower from one another, and is made inaccessible by securing the stem and flower together.

### FIELD OF THE INVENTION

This invention relates generally to funeral products, and more particularly to cremation urns for displaying cremated human remains contained therein.

### BACKGROUND OF THE INVENTION

Cremation is a growing segment of the funeral industry. Consequently, there is an increasing demand for more and higher quality styles and designs of cremation urns.

One popular design theme for cremation urns is the outdoor/animal theme. Four such designs are disclosed in U.S. Pat. Nos. Des. 356,421, 370,767, 370,766 and 370,768, all of which are assigned to the assignee of the present invention and are hereby incorporated by reference herein as if fully set forth in their entirety.

It is desirable to provide further advancements in the styles and designs of cremation remains containers.

### SUMMARY OF THE INVENTION

According to the principles of the present invention, a cremation remains container simulative of an ornamental plant comprises a stem and a flower. The stem and flower are removably securable together. One of the stem and flower includes a cremation remains compartment formed therein. The compartment is made accessible by removing or separating the stem and flower from one another, and is made inaccessible by securing the stem and flower together.

In one preferred embodiment, the compartment is formed in the stem. In another preferred embodiment, the compartment is formed in the flower.

The flower and stem are preferably removably securable together by way of female threads on one of the stem and flower and male threads on the other of the stem and the flower which are received by the female threads. In one preferred embodiment the stem includes the female threads and the flower includes the male threads. In another preferred embodiment the flower includes the female threads and the stem includes the male threads.

The stem further preferably includes at least one leaf thereon.

The flower is preferably a rose.

The stem further preferably includes a flattened area inscribable with a memorialization inscription.

These and other features and advantages of the present invention will become more readily apparent during the following detailed description taken in conjunction with the drawings herein, in which:

### BRIEF DESCRIPTION OF THE DRAWINGS

FIG. 1 is a perspective view of the cremation remains container simulative of an ornamental plant, and including stem and flower;

FIG. 2 is a view, similar to FIG. 1, with the flower and stem separated from one another; and

FIG. 3 is an enlarged partial perspective view of the stem including inscription region.

### DETAILED DESCRIPTION OF THE INVENTION

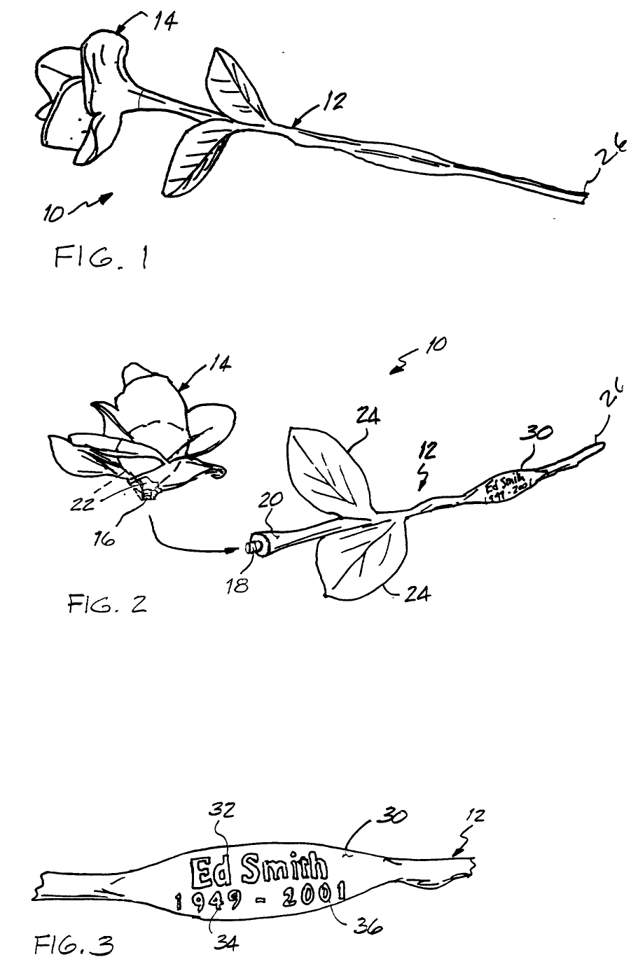

Referring first to FIG. 1 there is illustrated a cremation remains container 10 which is simulative of an ornamental plant. The container 10 comprises a stem portion 12 and a flower portion 14. The stem 12 and flower 14 portions are removably securable together.

Referring now to FIGS. 1 and 2, the flower portion 14 is shown separated from or otherwise removed from the stem portion 12. More particularly, the flower portion 14 includes a female threaded portion 16 which receives a male threaded portion 18 on end 20 of stem 12. Flower portion 14 may itself include a short section of stem if desired. A small compartment 22 is located within flower portion 14 for containing cremation remains. The compartment 22 is made accessible by removing the flower 14 from the stem 12, and is made inaccessible by securing the flower 14 to the stem 12. While the male threads have been shown as being a part of the stem 12 and the female threads have been shown as being a part of the flower 14, it will be appreciated to one of ordinary skill in the art that the male threads could just as well be a part of the flower 14 and the female threads could be a part of the stem 12. Other means for removably securing the stem 12 and flower 14 together may be employed such as snap-fit means, twist-lock means and the like, all of which are encompassed by the invention. In like fashion, the cremation remains compartment 22 could just as well be within the end 18 of the stem 12. Accordingly, all such variations are within the scope of the present invention. If desired, a small plug of material such as foam, putty or the like could be used to close or seal the remains within the compartment 22 prior to securing the stem 12 and flower 14 together. Alternatively, the compartment 22 could include internal or female threads (not shown) for accepting a hex screw or the like to secure the remains in the compartment 22.

The cremation remains container 10 may be fabricated of, for example, bronze, and as illustrated, is simulative of a rose. However, it will be appreciated that the container could be made in the form of many other ornamental plants, for example tulips, daisies, lilacs and the like and as such all are deemed to be within the scope of the present invention.

Stem 20 further includes a pair of leaves 24, thus adding to the realistic look of the container 10. Each portion of the container 10 may be painted to create a realistic appearance. For example, stem 12 may be painted brown, to simulate wood; flower 14 may be painted red or most any other color of rose and leaves 24 are preferably painted green in color. If desired, the lower end 26 of stem 12 can be appropriately sized so as to be usable as a tool to pack the remains and/or the sealing material within the compartment 22.

Referring now to FIGS. 2 and 3, there is illustrated a flattened portion or area 30 of the stem 12. Area 30 is suitable for engraving, for example, the name 32, date of birth 34 and date of death 36, as a memorial to the deceased. Other inscriptions such as poems, favorite sayings and the like could as well be inscribed on area 30.

Those skilled in the art will readily appreciate numerous adaptations and modifications which can be made to the present invention which will result in an improved cremation remains container, yet all of which will fall within the spirit and scope of the present invention as is defined in the following claims. Accordingly, the invention is to be limited only by the scope of the following claims.

What is claimed is:

1. A cremation remains container simulative of an ornamental plant, comprising:
a stem; and
a flower;
said stem and flower being memorably securable together;
one of said stem and said flower including a cremation remains compartment formed therein;
said compartment being made accessible by removing said stem and flower from one another, said compartment being made inaccessible by securing said stem and flower together.

2. The cremation remains container of claim 1 wherein said compartment is formed in said stem.

3. The cremation remains container of claim 1 wherein said compartment is formed in said flower.

4. The cremation remains container of claim 1 wherein one of said stem and flower includes female threads and the other of said stem and flower includes male threads received by said female threads.

5. The cremation remains container of claim 4 wherein said stem includes female threads and said flower includes male threads.

6. The cremation remains container of claim 4 wherein said flower includes female threads and said stem includes male threads.

7. The cremation remains container of claim 1 wherein said stem includes at least one leaf thereon.

8. The cremation remains container of claim 1 wherein said flower is a rose.

9. The cremation remains container of claim 1 wherein said stem includes a flattened area inscribable with a memorialization inscription.
